(19) United States
(12) Patent Application Publication
(10) Pub. No.: US 2024/0320655 A1
(43) Pub. Date: Sep. 26, 2024

(54) SYSTEM AND METHOD FOR PUBLIC DISPLAY OF MONEY GIFTS AT EVENTS WITH SIMULTANEOUS REAL-WORLD VISUALIZATION

(71) Applicants: Olumoroti G Balogun, Dallas, TX (US); Afis Ajala, Clifton Park, NY (US); Rukevwe A. Roti-Balogun, Dallas, TX (US)

(72) Inventors: Olumoroti G Balogun, Dallas, TX (US); Afis Ajala, Clifton Park, NY (US); Rukevwe A. Roti-Balogun, Dallas, TX (US)

(21) Appl. No.: 18/611,650

(22) Filed: Mar. 20, 2024

Related U.S. Application Data
(60) Provisional application No. 63/453,319, filed on Mar. 20, 2023.

(30) Foreign Application Priority Data
May 10, 2023 (NG) F/P/2023/137

(51) Int. Cl. G06Q 20/36; G06Q 20/10; G07F 11/62

(52) U.S. Cl. CPC G06Q 20/363; G06Q 20/10; G07F 11/62

(57) ABSTRACT

A system and method for public display of money gifts at events featuring an application for digitally transferring or dispensing funds with simultaneous real-world visualization. This system retains the visual experience and joyful emotions associated with throwing money gifts to celebrants while ensuring that the gifts do not risk exposure to germs and diseases, unlawful or undignified handling, and loss due to theft or natural elements. Gift givers and recipients are aware of the amount of money transferred or received in real time. Givers may give in bulk or with repeated swipes based on the denomination chosen by the giver. Givers enjoy the celebratory nature of gift giving at the event or remotely (since money gifts are transferred digitally) and strive to be the top giver, while recipients experience the joy and satisfaction of receiving gifts without the hassle of physically collecting money gifts, that may be damaged or stolen.

### FIELD OF THE INVENTION

The present disclosure relates generally to a system for virtually distributing financial gifts with simultaneous real-world visualization through virtual bill images/lights and/or physical methods involving retractable bills.

### BACKGROUND

In some cultures around the world, the public display of hard currency, i.e. money throwing (also known as money spraying), is used to celebrate important life events, and as a means to appreciate associations or friendships. Cash bills are physically sprayed on the recipient and the bills are later retrieved from the ground, where they may have been trampled, damaged or lost. The gift recipient may appoint a representative to physically pick up the bills but nefarious actors may also steal some bills without the knowledge of the gift recipient. Such public displays serve as a means for friends and families to make the recipient feel good and showcase the gift giver's excellent financial status or possibly feign it for self-satisfaction or gratification. A gift giver may even throw the bills individually to extend the time of the actual gift giving or to exaggerate the amount of money given/thrown at the recipient. However, this socially satisfying vice leads to the handling of national currencies in a non-dignifying manner, and has been rebuffed by some governments around the world. Problems have also been reported in situations when the sprayed money goes missing during handling by friends and family. Additionally, the recipient (or persons assigned by the recipient) will have to collect and count the money gifts in order to determine how much money was collected as gifts.

Prior art involves the use of money spraying guns, which may enable givers to spray money at a faster rate, but does not address the problems with money handling, missing money during handling, transmission of germs and diseases, unlawful trampling of money on the ground. Celebrants have also used money gift collection boxes, which may resolve the issues of missing money, germs and trampling bills but there is no gift recipient joy or gift giver social satisfaction (or bragging rights) as obtained from spraying of actual money bills.

More recently, social applications have been developed which feature electronic gifting of money, combined with the in-app chat features among giver/attendees. However, these applications deprive the gift recipient and giver of the joy of money spraying as such money gifting is without real-world visualization of the transfer or receipt of the money gift. Gift giving has also been combined with live-streaming wherein gift givers can compare and compete in real-time to impress gift recipient who can exchange the received gifts for money or jewels. Some gift recipients offer QR codes to guests to solicit monetary gifts through wiring funds or direct deposit to the recipient’ bank account. While these methods achieve the goal of delivering money gifts to celebrants, those celebrants will not feel the joy of being showered with money gifts. Those gift givers are also unable to derive the social utility of delivering money gifts directly to the gift recipient at an event.

The proposed system (dubbed Digital Spray) allows its users to “spray money” publicly with simultaneous visualization of the spent digital money. The Digital Spray system is powered by a phone or mobile application that allows its users to spray money digitally (in any chosen denomination) while simultaneously delivering a real-world visualization of the spent money (via a virtual images of money bills or other images or faux or fake paper money bills) thereby eliminating the risk of money loss during handling and unlawful demeaning of a national currency. The present invention is a paradigm shift from the current system of physical cash spraying or the more modern money gift applications and social networking platforms that focus on the transfer of funds to a system of digitally spraying money combined with simultaneous and real-world visualization of money spraying with lights, lasers and images of money for the visual and physical enjoyment both the gift giver and the gift recipient. The technology aims to deliver the same emotionally charged experience with physical cash spraying with the benefits of digital transfer of money gifts, but without the issues associated with spraying paper money bills.

An object of the present disclosure is to provide a system for digitally transferring money gifts while still enjoying the physical presentation and joy that comes with spraying or throwing money gifts.

Another object of the present disclosure is to provide gift givers with a method to spray money digitally while still enjoying the visual experience and stimulation (or social satisfaction) of spraying money.

Another object of the present disclosure is to avoid spreading germs and diseases that is possible with spraying paper money.

Another object of the present disclosure is to encourage additional gift giving as gift givers are informed of the gift giving of others and feel motivated to strive for a position as top gift giver.

Another object of the present disclosure is to provide the celebrant (gift recipients) with real-time knowledge of the total gifts collected.

Another object of the present disclosure is to enhance the beauty of the event by adding more color to the ceremony using real-world visualization that accompanies money spraying.

Another object of the present disclosure is to facilitate participation in money gift throwing ceremonies without contravening government laws regarding the undignified handling of national currency.

Another object of the present disclosure is to allow other cultures that are not currently engaged in public money spraying to embrace the culture since most humans enjoy self-satisfaction and gratification unless tamed.

Another object of the present disclosure is to provide a system to easily adjust the money spraying speed to the desires of the gift giver.

Another object of the present disclosure is to allow the giver to spray money remotely without being physically present at the event.

Another object of the present disclosure is to allow artists and performers to also receive money from the audience/attendees without physically touching or picking up cash bills.

Another object of the present disclosure is to eliminate the use of and need for money guns.

Another object of the present disclosure is to eliminate, or reduce significantly, money exchange fees charged when users change higher denomination cash to a lower denomination cash from money market.

### SUMMARY

The present invention is a system for digitally spraying money (to a celebrant) with simultaneous real-world visualization of the virtually sprayed money. This technology is a paradigm shift from the current money spraying culture that leads to the handling of national currencies in a potentially unlawful and non-dignifying manner, which may also be unhygienic. Traditional money spraying may also lead to loss of gifts as various people collect the money gifts on behalf of the gift recipients. As used herein, the gift giver is a person or persons that spent or sent money on the Digital Spray platform, which triggers a simultaneous real-world visualization of the money that has been spent or sent. The gift receiver/celebrant is a person or persons with an account on the Digital Spray platform that benefits monetarily and/or socially from the actions of the gift giver. Money spraying is the action of giving currency value in a social or celebratory manner visible to the public. Virtual money spraying is the display of digital images of money or lights or some other digital representations during money spraying using the Digital Spray platform. Another embodiment of the present disclosure may include faux money spraying, which is the dispensing of replica or fake money bills during money spraying using the Digital Spray platform.

In the current invention, the gift giver utilizes a digital device (that can be a phone application or any other digital input device) to set the total amount to be gifted to the gift recipient and the desired currency denomination to be sprayed. The present disclosure (henceforth referred to as Digital Spray) uses a phone application as the digital input device in this embodiment of the present invention. The Digital Spray app then initiates a transfer of the specified amount from the gift giver to the gift recipient (celebrant). On successfully transferring the total gift amount to the celebrant, the number of allowed spray actions is approximately computed as the quotient of the division of the total amount transferred and the denomination amount to be sprayed. The gift giver will be able to spray the celebrant based on the specified denomination until the number of allowed spray actions is reached. The Digital Spray app provides a method for the gift giver to still experience the joy of throwing “money” and for the gift recipient/celebrant to still experience the joy of being showered with “money gifts” as obtained in the currently available money spraying culture. The gift giver may use the Digital Spray app while physically present at the gift recipient's event or the gift giver may use the Digital Spray app from a location that is not the actual celebration location. Regardless of the location of the gift giver, the gift giver may receive joy from participating in the celebration and showering the gift recipient with a representation of a monetary gift. The Digital Spray app facilitates gift giving via swiping (or other motion such as button push, pull trigger, lever, switch or other custom giving motion). Each swipe, or other giving motion, will deplete the available number of spray actions by one until the number of allowed spray actions is exhausted. For example, if a giver specifies $100 and $20 as the total gift amount and the spraying denomination respectively on the Digital Spray app, then the giver will have 5 swipes which indicates that the full amount of the transferred gift has been sprayed. Alternatively, the gift giver may choose to deliver the gift in bulk, wherein the entire gift would be transferred to the gift recipient in a single swipe motion. In either case, if the gift giver continues to swipe after the gift amount is depleted, such swipes (or money spraying) will not be accompanied by a simultaneous real-world visualization. The Digital Spray app may also prompt the gift giver to initiate an additional money transfer to start another round of money spraying. The gift giver may also decide to give additional money gifts upon notification that said gift giver is no longer the top gift giver to the gift recipient.

The Digital Spray system eliminates the loss of money caused by physical handling of money (due to theft or loss) after spraying the money since the money gift is electronically transferred from the gift givers to the gift receivers via the Digital Spray app. At the end of the gift giving session, the Digital Spray app will transfer the gifted funds to the recipient's chosen account. The gift giver can determine the amount to be spent without any chance or fear of exceeding the set amount thereby saving money. Gift givers are often distracted by the joy of the celebration and may not pay close attention to the specific amount of money being sprayed. Similarly, the gift recipient is also not paying close attention to the amount of money thrown, which allows for thieves to pilfer some bills or for bills to be misplaced, lost or blown away. Gift givers that physically toss cash bills toward gift recipients can quickly get caught up in the excitement of the celebration and toss more money gifts than said gift giver originally intended. Additionally, there is no accurate way for a gift giver throwing paper bills to determine the amount of the gift. Further, the gift recipient of thrown paper bills will not know the total gifts from all celebration attendees until all paper money bills are gathering and individually counted. Even then, the gift giver will likely remain ignorant of any paper money bills lost to theft or the wind. The Digital Spray app resolves these issues for the gift giver as well as the gift recipient since the transfer of money gifts is electronic along with a visualization component that is not available with a common fund transfer via CashApp or Zelle or a similar payment system. Additionally, other celebration attendees will experience the joy of the visualization of the money gift with Digital Spray app, unlike a regular electronically transferred money gift, for which only the gift giver will receive a notification of the money gift.

Additionally, the parties, both gift giver and gift recipient, will be subjected to zero or lower money exchange fees when the money gift transfer is digital since these exchange fees may increase with a request for lower denominations of real cash. For example, a higher exchange fee may be charged for five $100 bills versus twenty-five $20 bills. For a total gift of $500, a gift giver may prefer $20 bills in order to experience spraying 25 times in lieu of $100 bills that allows 5 sprays on the Digital Spray platform.

Gift givers may also avoid running afoul of local laws or facing charges or sanctions by governments who have made laws against trampling, throwing or otherwise disrespecting their national currency. The Digital Spray technology is faster, cheaper and more tolerated or accepted by cultures and governments around the world.

Real-world visualization system of the digital spray technology can be virtual (digital display or lights) or by faux money. In the virtual visualization system, the Digital Spray phone app is connected to the virtual visualization module via a Bluetooth, Wi-Fi or internet of things (IoT) connection. The virtual visualization module is connected to a client (via a network interface module) that facilitates interaction between the Digital Spray app and the visualization module. The virtual visualization module is composed of a power and control component that ensures that the display unit gets adequate power to allow the display unit to respond promptly to the swipes (button push or other gestures) that are coming from the Digital Spray phone app (FIG. 3). The virtual display system of the Digital Spray technology can be composed of laser display, light emitting diode (LED), Organic LED or Quantum LED but is not limited to these.

Alternatively, some celebrants may prefer to be sprayed with faux money or replica money. For such users, the faux money module of the Digital Spray technology will be adopted in lieu of the virtual visualization module. The faux money visualization module of the Digital Spray invention is also connected to the phone application via a IoT, Bluetooth or Wi-Fi connection (FIG. 2). The faux money visualization module is connected to a client (via a network interface module) that facilitates interaction between the Digital Spray app and the faux money dispenser. The power and control system of the faux money visualization module ensures that the faux money dispenser gets adequate power that will enable it to respond promptly to the digital instructions of the phone application. The faux money dispenser can be a money fountain that throws money upward from the ground, or a system hanging above the celebrant that drops faux money on the celebrant from the top towards the ground. The faux money can be either magnetic or non-magnetic money. The magnetic faux money contains a magnetic embedding that enables its automatic return to the money dispenser module after its release from the faux money dispenser via a magnetic pathway. On the contrary, the non-magnetic faux money has no magnetic embedding but has a light-weight string attached to it that facilitates its return to the money dispenser after it has been dispensed. The number of displayed faux money (and hence the total display time) is determined by the total transfer amount and the denomination set by the giver.

Further, the Digital Spray phone or computer application handles money transfers through third party platforms such as PayPal, Western Union, CashApp, Zelle, Venmo or with digital wallet systems. The Digital Spray system and application will facilitate the transfer of actual funds while allowing both gift givers and gift recipient to enjoy the experience of spraying or being sprayed with “money” gifts. Other technical features may be readily apparent to those skilled in the art from the following figures and descriptions.

### BRIEF DESCRIPTION OF THE DRAWINGS

For a more complete understanding of this disclosure and its features, reference is now made to the following description, taken in conjunction with the accompanying drawings, in which:

FIG. 1 shows an overview flowchart showing the Digital Spray technology system.

FIG. 2 shows the flowchart for faux money visualization of the Digital Spray technology system.

FIG. 3 shows the flowchart for the virtual visualization of the Digital Spray technology system.

FIG. 4 shows modules for the virtual visualization system of the Digital Spray technology system with a demonstrative display.

FIG. 5 shows the details of the phone application for the Digital Spray technology system.

FIG. 5A shows the home screen of the Digital Spray technology system.

FIG. 5B shows the events screen of the Digital Spray technology system.

FIG. 5C shows the wallet screen of the Digital Spray technology system.

FIG. 5D shows the give screen of the Digital Spray technology system.

FIG. 5E shows the spray money screen of the Digital Spray technology system.

FIG. 5F shows the settings screen of the Digital Spray technology system.

FIG. 6 shows the software architecture of the Digital Spray application.

### DETAILED DESCRIPTION

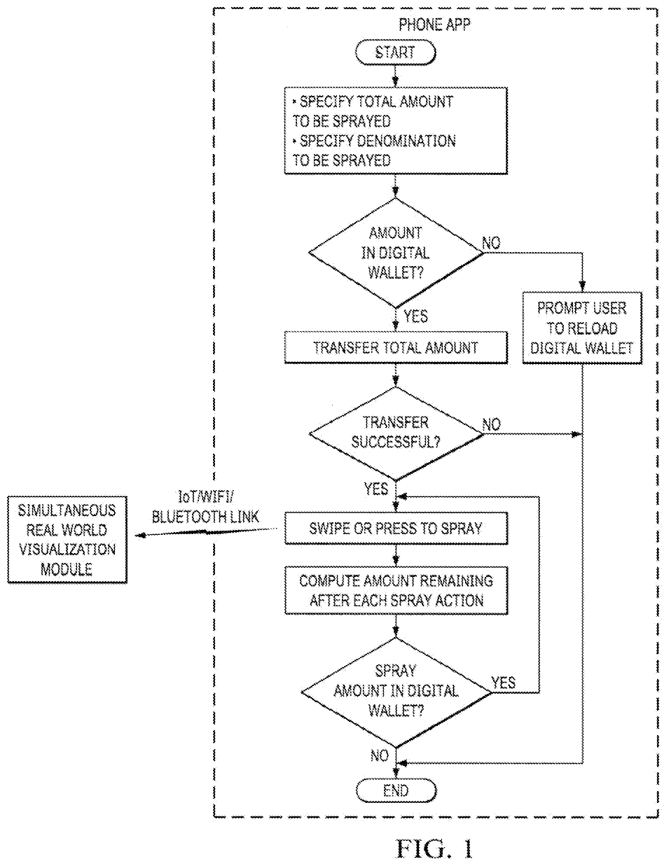

FIG. 1 shows overview flowchart of the Digital Spray technology. On creating an account on the Digital Spray app, the gift giver is assigned an in-app digital wallet. The gift giver initially selects the amount of gift to be transferred to the celebrant and the denomination amount to be sprayed. The Digital Spray app then verifies that the total amount to be sprayed does not exceed the total amount in the giver's wallet. If the total amount to be sprayed is not verified, the gift giver is prompted to load funds to the gift giver's digital wallet. If the total amount to be sprayed is not available in the in-app digital wallet, the transaction will be terminated. If the total amount to be sprayed is verified to be in the in-app digital wallet, the Digital Spray app initiates a transfer of the specified amount from the gift giver to the gift recipient or celebrant. Funds may be transferred through banking institutions, Stripe, PayPal, Western Union, Zelle, Venmo, CashApp, digital wallet and any funds transfer system. On successfully transferring the total gift amount to the celebrant's in-app wallet, the gift giver will be able to spray the celebrant with money based on the previously specified denomination until the amount in the gift giver's in-app wallet is less than the amount to be sprayed. The Digital Spray app provides a method for the gift giver to still experience the joy of throwing “money” and for the gift recipient/celebrant to still experience the joy of being showered with “money gifts” as obtained in the currently available money bill spraying. The Digital Spray app provides the giver with a push button or a surface that facilitates swiping or other custom gestures (such as pull trigger, lever, switch) and each swipe, button push or custom gesture will deplete the giver's in-app wallet by the sprayed amount.

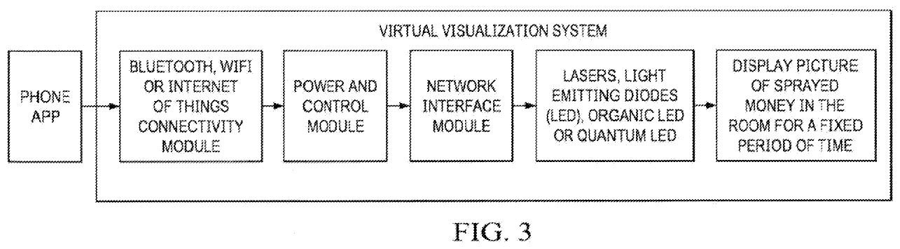

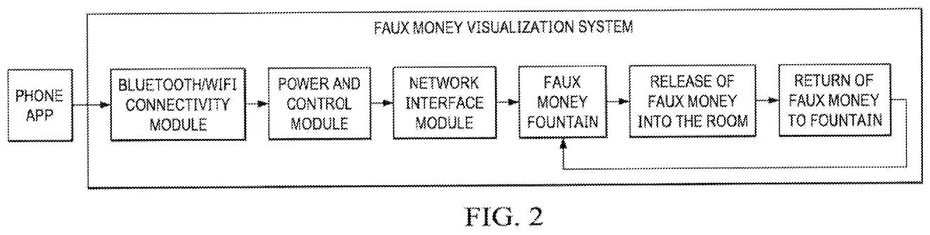

FIG. 2 shows the faux money visualization system of the Digital Spray app. The faux money visualization module is connected to the phone application via a Bluetooth, Wi-Fi or IoT connection. The faux money dispenser is connected to a client (via a network interface module) that facilitates interaction between the Digital Spray app and the dispenser. The power and control system of the module ensures that the faux money dispenser gets adequate power that will enable it to respond promptly to the digital instructions of the phone application. The faux money dispenser can be a money fountain that throws money upward from the ground, or a system hanging above the celebrant that drops faux money on the celebrant from the top towards the ground. The faux money can be either magnetic or non-magnetic money. The magnetic faux money contains a magnetic embedding that enables its automatic return to the money dispenser via a magnetic pathway after coming out of the dispenser. On the contrary, the non-magnetic faux money has no magnetic embedding but may have a light-weight string, or similar retraction device, attached to it that facilitates its return to the money fountain after it has been dispensed. The number of displayed faux money bills (and hence the total display time) is determined by the total transfer amount and the denomination set by the giver. As such, more bills take more time to display or shower and fewer bills take less time.

FIG. 3 shows the virtual visualization system of the Digital Spray app. The output of the virtual visualization module can be in the form of digital pictures of currency and lasers and/or light emitting diodes (LED), organic LED or quantum LED, that is simultaneously displayed when the gift giver sprays money. The Digital Spray app is connected to the virtual visualization module via a wireless connection technology such as Bluetooth or Wi-Fi connection. The virtual visualization module is composed of a power and control module that ensures that the display unit gets adequate power to allow it respond promptly to the swipes (button push or other gestures) that are coming from the Digital Spray app. The virtual visualization module is connected to a client (via a network interface module) that facilitates interaction between the Digital Spray app and the visualization module. The result is a display of virtual money towards the gift recipient for a finite period of time. In order to shower the recipient with money gifts, the Digital Spray app uses lasers, LEDs, organic LED or quantum LED to produce visual content, which will be a displayed picture of sprayed money for a fixed period of time. The number of displayed virtual money (and hence the total display time) is determined by the total transfer amount and the denomination set by the giver. The length of time for the display of the money images is directly correlated to the amount of the money gift, more display time for more money and less display time for smaller money gifts.

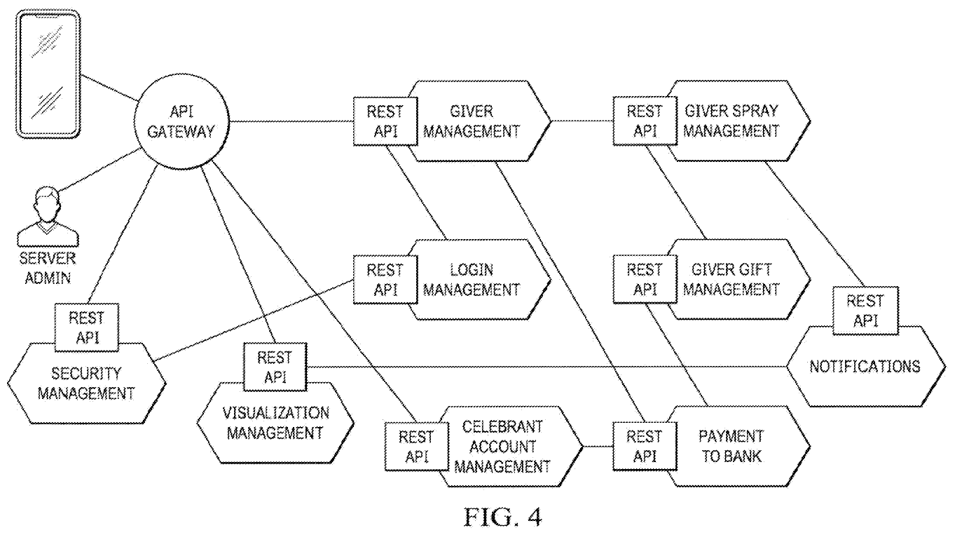

FIG. 4 shows the software architecture for the Digital Spray application. The user can download the Digital Spray app onto their personal device, such as a cellular phone or tablet, and access various in-app functionalities via the API (application programming interface) Gateway. In-app functionalities such as gift giver management (administration of attended events), gift giver spray management (administration of total gifts, chosen denominations, calculation of spray actions, total funds available in the in-app digital wallet), login management (administration of gift giver and gift recipient access to Digital Spray app), giver gift management (administration of total gifts to various gift recipients, verified and unverified money transfers), security management (administration of gift giver and gift recipient account security for Digital Spray app), visualization management (administration of display of visualizations using lasers imagery, LED, quantum LED or organic LED systems), gift recipient/celebrant account management (monitoring account activity such as created events and total money received), and payment to bank (transfer of funds to banking institution) are powered by custom microservices that communicate with each other via REST (Representational State Transfer) API.

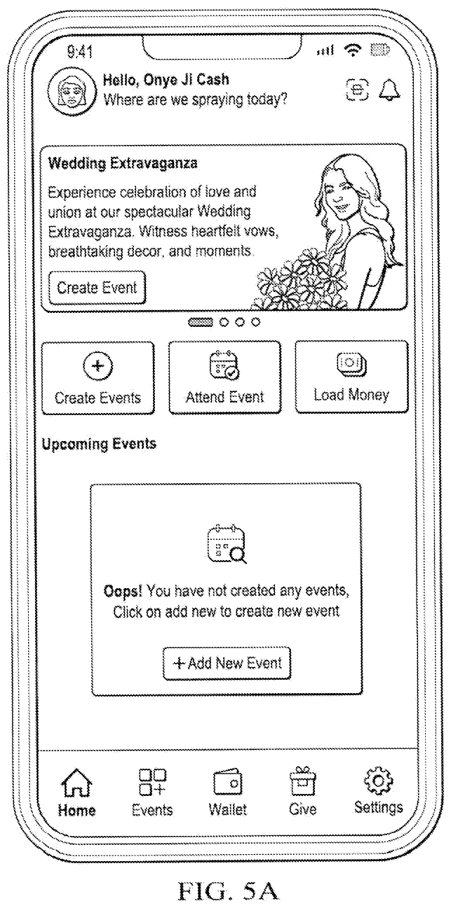

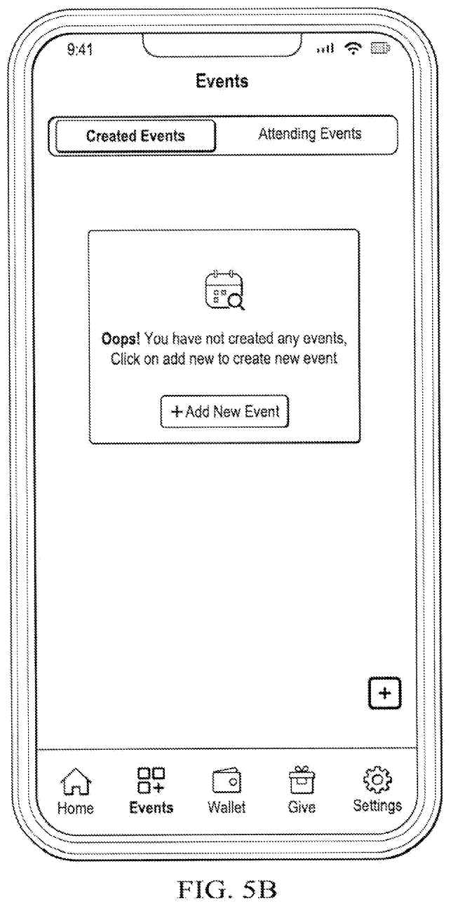

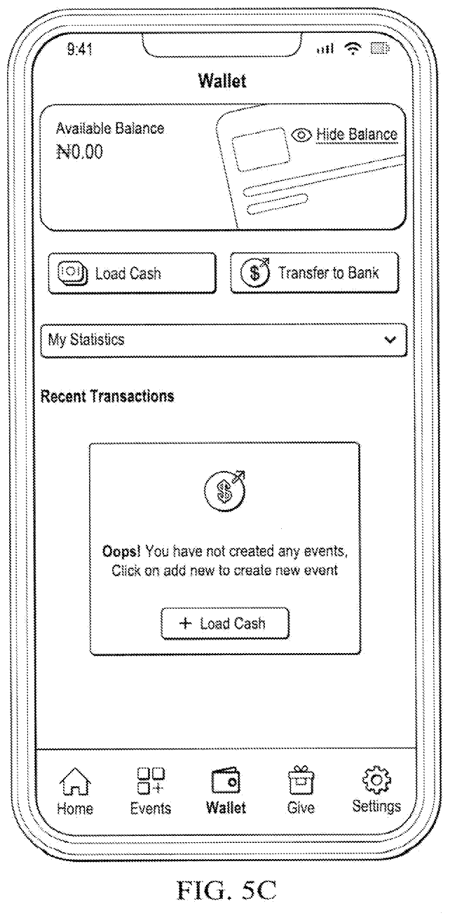

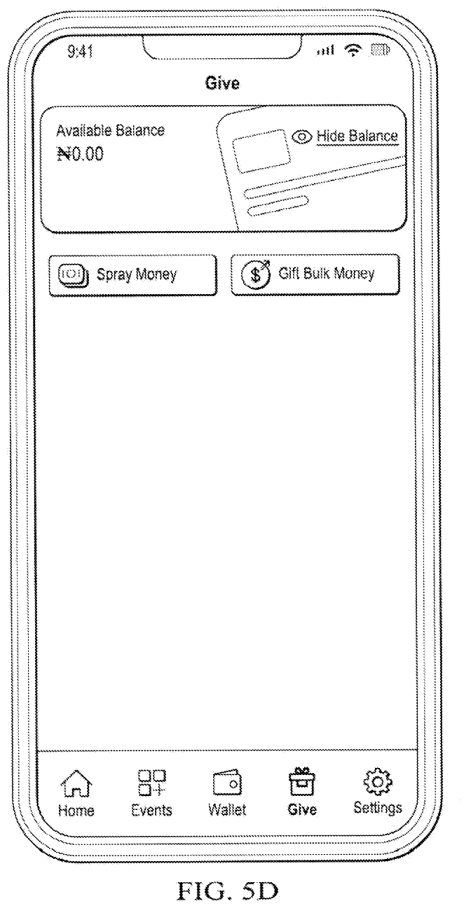

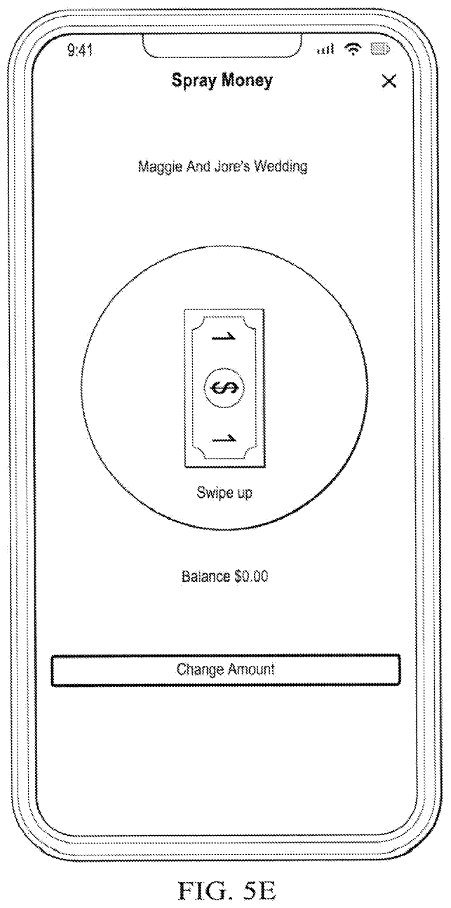

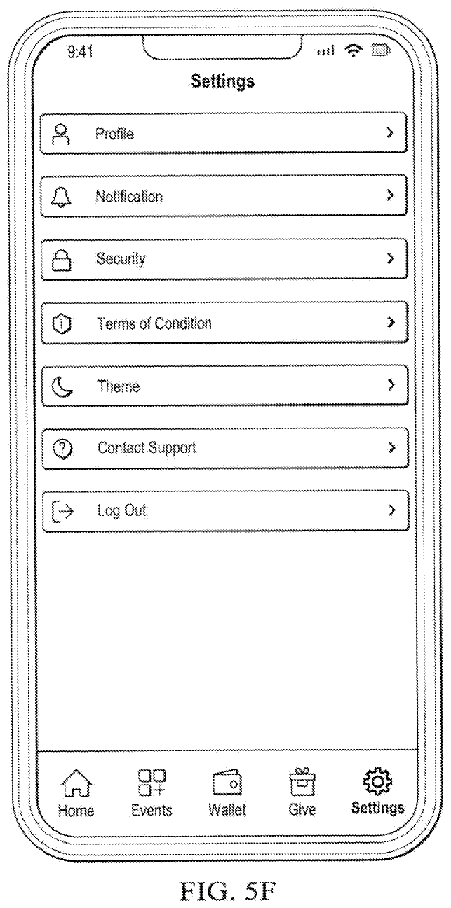

FIG. 5 shows the details of the phone application for the Digital Spray technology system. The current embodiment of the Digital Spray app displays HOME, EVENTS, WALLET, GIVE and SETTINGS, as discussed below. It is to be understood that various functionalities described herein are available to all users of the Digital Spray app, gift givers as well as gift recipients/celebrants.

HOME (FIG. 5A) After downloading and installing the Digital Spray app, the gift recipient/celebrant lands in the “Home” screen of the app. A new event can be added from the home screen. Creating an event allows the gift recipient to identify the date and time for the gift recipient's special day. The gift recipient can also indicate the type of event, which may be a wedding, birthday, homegoing celebration or any other event for which money gifts are typically showered on the gift recipient, guest of honor or their family. The gift giver has the option to “Attend Events”, which will display upcoming events to the gift giver, who simply has to select the desired event in order to share a money gift with that particular gift recipient or celebrant. Once a particular event is selected, the gift giver has the option to “Load Money” into their in-app digital wallet, which facilitates a transfer of funds from the gift giver's account to the celebrant's digital wallet in the Digital Spray App. At the conclusion of the celebration, the celebrant has the option of transferring the amount in their in-app wallet to their personal bank account or keep it in their in-app wallet.

EVENTS (FIG. 5B) Users of the Digital Spray app can easily see a listing of their own “Created Events”, which are events set up by a gift recipient in the Digital Spray app and “Attending Events”, which are events that the gift giver has been invited to attend. All Digital Spray app users can toggle between “Created Events” and “Attending Events”. A gift recipient user/celebrant can select the (+) icon to “Add New Event” to the Digital Spray app and gift giver users can locate the newly created event (via a unique in-app generated alpha-numeric or QR code) and add the upcoming event to their own Digital Spray app profile. The celebrant sets the date, time, and occasion for the new event within the Digital Spray app. All users, including gift recipients and gift givers, can see the upcoming events connected to that user's profile. Any other Digital Spray app user/giver with the event code can RSVP for the event and the details of the event will automatically appear in the user's Attending Events tab. Gift givers are able to spray the celebrant once they enter the celebrant's event and specify a spray denomination.

WALLET (FIG. 5C) The “Wallet” (in-app digital wallet) of the Digital Spray app shows the user the available balance, allows the user to “Load Cash” to increase the amount of money gifts available for distribution to celebrants. The money gifts may be transferred from the gift giver user's bank account, CashApp, Venmo, PayPal or other funds transfer system. The Digital Spray app allows gift recipient users to “Transfer to Bank”, which allows the gift recipient to move gifted money funds from the Digital Spray app wallet over to the gift recipient user's bank account of choice or other funding processing app or system. If the user does not select the eye icon to “Hide Balance”, then the Available Balance will be visible within the Wallet page of the Digital Spray app. If the user selects “Hide Balance”, then the Available Balance will not be displayed on the Wallet page of the Digital Spray app. The “My Statistics drop-down menu allows the user to see analytics of cumulative/long term details of spend and receive activities at different points in time. Additionally, the gift giver can track their “Recent Transactions” to monitor the amount of money gifts, and to whom those gifts were given. The “Wallet” page of the Digital Spray app also allows the gift recipient user to track the total of gift money accumulated in real time as the event progresses and eventually concludes. The user may also select “+Load Cash” to add money gifts for future giving at upcoming events or to add money gifts to events occurring in real time. Once the money gift has been added to the Digital Spray app, the gift giving user can then select the denominations for dispersing the money gift to the gift recipient user in the GIVE page of the Digital Spray app.

GIVE (FIG. 5D) Once the gift giver selects the “Give” icon, the Digital Spray App will display the balance of funds ready for gift giving. The gift giver may begin the distribution (or spray) of money gifts by swiping “Spray Money”. By selecting “Gift Bulk Money”, the gift giver may choose to release the entire money gift at one time instead of with repeated swipes to release the money in the designated denominations. If the user does not select the eye icon to “Hide Balance”, then the Available Balance will be visible within the Wallet page of the Digital Spray app. If the user selects “Hide Balance”, then the Available Balance will not be displayed on the Wallet page of the Digital Spray app

SPRAY MONEY (FIG. 5E) Once “Spray Money” is selected, the gift giver will deplete the balance by single swipes for the release of the money gift in the designated denomination to the celebrant's in-app wallet. The denomination designated by the gift giving user will be displayed on the Spray Money screen (For U.S. dollars, $1 in this view but the gift giver may select $5, $10, $20, $100 or any other denomination of their choice). Further, it is to be understood that the present invention is not restricted to dollars since the invention may be used with any currency in any country. Once the balance reaches zero (or the amount remaining in the wallet is less than the denomination), the gift giver will no longer be able to release money gifts with swipes. The gift giver will have the option to “Change Amount” from the Spray Money screen or “+Load Cash” from the Wallet screen, if the gift giver wants to add additional funds to the money gift and start swiping to disburse money gifts to gift recipient again.

SETTINGS (FIG. 5F) When the user selects “Settings”, the user will be able to access Profile, Notification, Security, App Guidelines, Terms of Condition, Theme, Contact Support, and Log Out. The user can add as much or as little information to their user profile as desired. The profile may include name, email, photograph, city of residence, or other information desired to be shared by the user. The Notification page allows a user to indicate which, if any, notifications the user wishes to receive from the Digital Spray app, such as reminders about upcoming events, money gifts have been depleted, the user has given the largest money gift for a particular event, the user can increase their gift by a certain amount to be the highest gift giver for a particular event, a user's attempt to load money was unsuccessful or other notifications as needed. The Security tab includes features such as two-factor authentication and password reset. The Terms of Condition includes information related to the terms to which the Digital Spray app user consents in exchange for access to the Digital Spray app. The Theme option allows a user to select a color scheme or other personalization features for the display of the Digital Spray app on that user's personal device. The Contact Support option will connect the user to online support agents or email or phone support for assistance with operations of the Digital Spray app. The user may also select Log Out from Settings to exit the Digital Spray app.

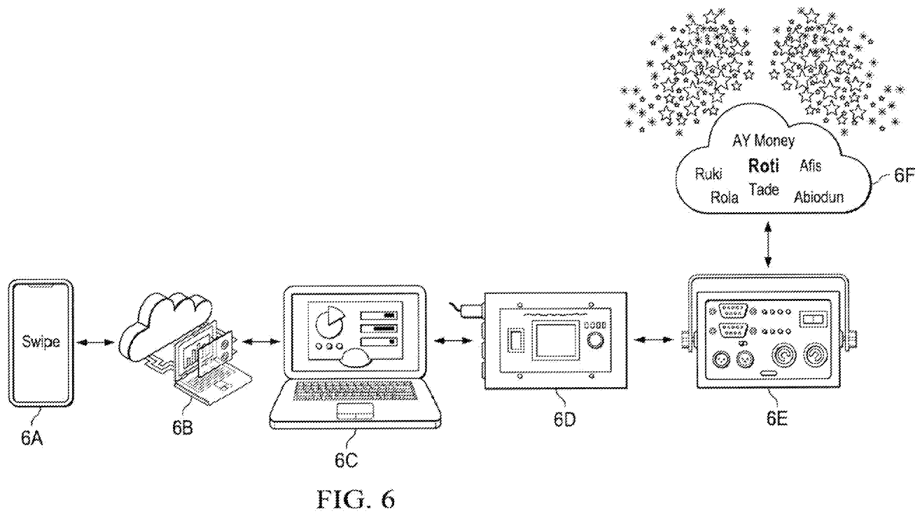

FIG. 6 shows the modularization of the Digital Spray technology system (with a demo display) for the present embodiment of the invention. However, each module of the Digital Spray app may be replaced with other devices with a similar functionality. This particular embodiment features a cellular phone, cloud-based implementation, host computer, an FB4 module (such as the one from Pangolin Laser Systems or similarly functioning device) to interface between host computer and laser device, and a laser device for dynamic visualization of the money gifts, which appears as a laser visualization initiated by the swipe of the cellular phone. The present figure shows the text of the gift givers' names scaled according proportionally to the amount gifted by the individual, i.e. larger names for larger gifts. Once the gift giver has located the gift recipient's event in the Digital Spray app, the gift giver would swipe the cellular phone (or other personal device upon which the Digital Spray app is installed).

What is claimed is:

1) A system for the virtual display of money gifts at events comprising:
A personal computing device;
A gift visualization computer application configured to
Associate a money gift transferred into said computer application with a specific event;
Identify an amount of said money gift as input by first user,
Identify a denomination unit as input by a first user,
Verify that said amount of said money gift is present in a digital wallet of said first user,
Transfer said amount of said money gift to a digital wallet of said second user, calculate a number of release actions by dividing said amount of said money gift by said denomination unit,
Reduce said amount of said money gift by said denomination unit for each release action;
Display a single visualization of said denomination unit for each element of said number of release actions, reducing said number of release actions by one for each of said visualizations until said number of release actions depletes to zero;
Terminate activity when the remaining amount of said money gift is less than said denomination unit or the number of remaining release actions is zero; and
Transfer the total money gifts received by said second user in said digital wallet to an account of said second user; and
A visual exhibition system of said money gifts.

2) The system for the virtual display of money gifts at events of claim 1, wherein said personal computing device may be selected from the group consisting of: cellular phone, tablet, and personal computer.

3) The system for the virtual display of money gifts at events of claim 2, wherein said visual exhibition system of said money gifts is further comprised of:
said gift visualization computer application connected to a power and control module,
said power and control module connected to said network interface module for a user,
said network interface module connected to a money gift dispenser.

4) The system for the virtual display of money gifts at events of claim 3, wherein said money gift dispenser is further comprised of:
a storage compartment for replicas of said money gifts,
a device for releasing said money replicas of said money gifts from said money gift dispenser, and
a device for returning said money replicas of said money gifts to said money gift dispenser.

5) The system for the virtual display of money gifts at events of claim 4, wherein said device for releasing said money replicas of said money gifts from said money gift dispenser is comprised of magnetized money replicas, wherein said device for returning said money replicas of said money gifts to said money gift dispenser contains additional magnetic properties for the attraction of said magnetized money replicas to said money gift dispenser.

6) The system for the virtual display of money gifts at events of claim 3, wherein said account is maintained outside said system for virtual display of money gifts, wherein said account is selected from the group consisting of: checking account, savings account, Stripe, PayPal, Western Union, Zelle, Venmo, CashApp, digital wallets and any similar funds transfer system.

7) The system of claim 6, wherein said release action is selected from the group consisting of swipe screen, push button, pull trigger, lever, switch, or other gestures of selection.

8) The system for the virtual display of money gifts at events of claim 1, wherein said visual exhibition system of said money gifts is further comprised of:
said gift visualization computer application connected to a power and control module,
said power and control module connected to said network interface module for a user,
said network interface module controls the output of said visual exhibition system, wherein said output of said visual exhibition system is further selected from the group consisting of lasers, lights, and images of said money gifts.

9) The system for the virtual display of money gifts at events of claim 8, wherein said lights are further selected from the group consisting of organic light emitting diodes and quantum light emitting diodes.

10) The system for the virtual display of money gifts at events of claim 1, wherein said events are further selected from the group consisting of: wedding, birthday, homegoing, funerals, and parties.

11) A method of transferring a money gift to a gift recipient during a celebration event, consisting of:
Selecting a total amount for a money gift;
Selecting a denomination unit of said money gift;
Transferring funds in the total amount of said money gift to a gift delivery application from a financial account of a gift giver;
Calculating a number of release actions by dividing said total amount for said money gift by said denomination unit of said money gift;
Performing at least one said release action to deplete a denomination unit of said money gift from said total amount for said money gift, wherein said release action automatically activates a simultaneous visualization of said release action with a visual light effect visible to said gift recipient;
Repeating said release actions until the number of release actions is equivalent to the value generated by dividing said total amount for said money gift by said denomination unit of said money gift;
Terminating said release actions at a point in time wherein said remaining amount of money gift is less than said denomination unit; and
Transferring funds from said gift delivery application to a bank account of said gift recipient.

12) The method of transferring a money gift to a gift recipient of claim 5, wherein said release action is selected from the group consisting of swipe, push button, pull trigger, lever, switch, or other physical gestures of selection.

13) The method of transferring a money gift to a gift recipient of claim 5, wherein said visualization is selected from the group consisting of: images of money, lasers, organic light emitting diodes and quantum light emitting diodes.

14) The method of transferring a money gift to a gift recipient of claim 5, wherein said visualization is selected from the group consisting of: magnetized faux paper money, non-magnetized faux paper money, and faux paper money with retractable string.

15) The system of claim 3, wherein said light emitting diode may be selected from the group consisting of organic light emitting diodes and quantum light emitting diodes.

16) A method of transferring money gifts to recipients consisting of:
Selecting an amount for a monetary gift;
Selecting a denomination of bills of said monetary gift;
Transferring funds in the amount of said monetary gift to a gift delivery application;
Performing a gesture repeatedly to virtually and visually release each unit of said monetary gift in the direction of said recipient; and
Transferring funds from a gift delivery application to the financial account of said recipient.
